(19) United States
(12) Patent Application Publication
(10) Pub. No.: US 2015/0177793 A1
(43) Pub. Date: Jun. 25, 2015

(54) HDMI storage device, HDMI flash drives, HDMI jump drives

(71) Applicant: KALAM CHOWDHURY, JERSEY CITY, NJ (US)

(72) Inventor: KALAM CHOWDHURY, JERSEY CITY, NJ (US)

(21) Appl. No.: 14/532,101

(22) Filed: Nov. 4, 2014

Related U.S. Application Data
(60) Provisional application No. 61/919,509, filed on Dec. 20, 2013.

(51) Int. Cl. G06F 1/18

(52) U.S. Cl. CPC G06F 1/182

(57) ABSTRACT

Like currently used USB Flash drives this (HDMI Flash drive) is a removable flash drive but it will use HDMI ports or mini HDMI ports or other types of HDMI ports. It will transfer data at past, present and future HDMI compatible speed or higher speed. This new group of device can hold data volume from 1 KB to 1000 GB or more as needed and produced by manufacturer. Dimensions will be close to the size of any current USB flash drives. Shape will be as needed.

Like currently used USB Flash drives this is a removable flash drive but it will use HDMI ports or mini HDMI ports or other types of HDMI ports. It will transfer data at past, present and future HDMI speed.

This new group of device can hold data volume from 1 KB to 1000 GB or more as needed and produced by manufacturer.

Dimensions will be close to the size of any current USB flash drives. Shape will be as needed.

What is claimed is:

1. HDMI flash drive &/or HDMI jump drive &/or Removable HDMI media drive.
Flash drives available in the market are using USB ports. This “HDMI flash drive &/or HDMI jump drive &/or Removable HDMI media drive” will use HDMI ports and transfer data at HDMI compatible or faster speed. This is a removable storage device to store digital contents. The storage capacity may range from few KBs to many GBs, depending on manufacturers customization. It will use HDMI ports in different electronic devices including but not limited to PC, MAC, Digital cameras, TV, cellphones, tablets, Phablets, PlayStation, Xboxes etc.
